(19) United States
(12) Patent Application Publication
(10) Pub. No.: US 2025/0023798 A1
(43) Pub. Date: Jan. 16, 2025

(54) CONFIGURABLE SUPPORT FOR GENERIC VIRTUALIZED INFRASTRUCTURE MANAGER RESOURCES

(71) Applicant: Telefonaktiebolaget LM Ericsson (publ), Stockholm (SE)

(72) Inventors: Zoltan Peter TOTH, Pilisvörösvár (HU); Xuejun LI, Princeton Junction, NJ (US); Stefan BJURSTRÖM, KARLSKRONA (SE)

(21) Appl. No.: 18/717,150

(22) PCT Filed: Jun. 13, 2022
(86) PCT No.: PCT/EP2022/065930

§ 371 Date: Jun. 6, 2024

Related U.S. Application Data
(60) Provisional application No. 63/288,445, filed on Dec. 10, 2021.

(51) Int. Cl. H04L 41/40; H04L 41/0895

(52) U.S. Cl. CPC H04L 41/40; H04L 41/0895

(57) ABSTRACT

A network node can be configured to provide a network function virtualization orchestrator (“NFVO”) in a virtualization environment. The network node can determine that information associated with an unrecognized resource meets criteria associated with a reference definition for a type of recognized resource. The network node can, responsive to determining that the information associated with the unrecognized resource meets the criteria, store an indication of the unrecognized resource as a recognized resource.

### TECHNICAL FIELD

The present disclosure is related to wireless communication systems and more particularly to configurable support for generic virtualized infrastructure manager resources.

### BACKGROUND

Orchestration systems, like a network function virtualization orchestrator (“NFVO”) in the European Telecommunications Standards Institute (“ETSI”) Management and orchestration (“MANO”) architecture, usually support onboarding and deployment of native virtualized infrastructure manager (“VIM”) orchestration templates (e.g., Openstack heat orchestration template (“HOT”), Azure's Azure Resource Manager (“ARM”), Amazon Web Service (“AWS”) cloud formation (“CFN”)). The deployment of such templates is done by passing the templates to the orchestration subsystem of the VIM (e.g., Openstack Heat, Azure Resource Manager, AWS Cloudformation).

Deployment of such a template in the VIM can create several types of VIM resources. The NFVO may not recognize each of these resource types, but only a subset of them. Information about the recognized subset of these VIM resources is stored by the NFVO. These resources are known as virtual assets in the NFVO.

The NVFO typically offers a proprietary North-Bound Interface (“NBI”) for the NBI clients to query the NFVO specific representation of these assets. This NBI can be used by external management systems to collect information and discover the relations (e.g., dependency, connectivity, topology) between the virtual resources deployed via the NFVO.

There can be dependencies stored in the database of the NFVO between the assets, which can be used to reject deletion attempts of assets that other assets depend on.

### SUMMARY

According to some embodiments, a method of operating a network node is provided. The network node is configured to provide a network function virtualization orchestrator (“NFVO”) in a virtualization environment. The method includes determining that information associated with an unrecognized resource meets criteria associated with a reference definition for a type of recognized resource. The method further includes, responsive to determining that the information associated with the unrecognized resource meets the criteria, storing an indication of the unrecognized resource as a recognized resource.

According to other embodiments, a network node configured to provide a network function virtualization orchestrator (“NFVO”) in a virtualization environment is provided. The network node includes processing circuitry and memory coupled with the processing circuitry. The memory includes instructions that when executed by the processing circuitry causes the network node to perform operations. The operations include determining that information associated with an unrecognized resource meets criteria associated with a reference definition for a type of recognized resource. The operations further includes, responsive to determining that the information associated with the unrecognized resource meets the criteria, storing an indication of the unrecognized resource as a recognized resource.

According to other embodiments, a network node, computer program, or computer program product is provided to perform the above method.

Certain embodiments may provide one or more of the following technical advantages. In some examples, support is added for quickly storing and exposing new resource types. As the number of resource types may be very high (and grow dynamically, for example for a HCP), this may speed up adding support for query of new types of such VIM resources via the NFVO NBI.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating an example of a orchestration management system overview according to some embodiments of inventive concepts;

FIG. 2 is a block diagram illustrating an example of a function allocation in a Network Function Virtualization Orchestrator (“NFVO”) according to some embodiments of inventive concepts;

FIG. 3 is a flow diagram illustrating an example of an outline of the Virtual Network Function (“VNF”) deployment logic according to some embodiments of inventive concepts;

FIG. 4 is a flow diagram illustrating an example of changes to a VNF resource synchronization process according to some embodiments of inventive concepts;

FIG. 5 is a diagram illustrating an example of a reference definition according to some embodiments of inventive concepts;

FIG. 6 is a diagram illustrating an example of a list of match criteria according to some embodiments of inventive concepts;

FIG. 7 is a diagram illustrating an example of a list of deployed resources returned by a VIM according to some embodiments of inventive concepts;

FIG. 8 is a diagram illustrating an example of a NFVO querying a JSON object from an Azure VIM according to some embodiments of inventive concepts;

FIG. 9 is a diagram illustrating an example of a VNF data query response addition returned on the NFVO NBI according to some embodiments of inventive concepts;

FIG. 10 is a diagram illustrating an example of a generic resource details query response returned on the NFVO NBI according to some embodiments of inventive concepts;

FIG. 11 is a flow diagram illustrating an example of changes to the NFVO asset deletion logic according to some embodiments of inventive concepts;

FIG. 12 is a flow diagram illustrating an example of changes to the NFVO VNF deletion logic according to some embodiments of inventive concepts;

FIGS. 13-17 are flow charts illustrating an example of operations performed by a network node configured to provide a NFVO according to some embodiments of inventive concepts;

FIG. 18 is a block diagram of a communication system in accordance with some embodiments;

FIG. 19 is a block diagram of a user equipment in accordance with some embodiments

FIG. 20 is a block diagram of a network node in accordance with some embodiments;

FIG. 21 is a block diagram of a host computer communicating with a user equipment in accordance with some embodiments;

FIG. 22 is a block diagram of a virtualization environment in accordance with some embodiments; and

FIG. 23 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The types of VIM resources supported in native VIM orchestration templates can be much higher than the resource types recognized by the Network Function Virtualization Orchestrator (“NFVO”) and may grow substantially with new VIM releases or updates to a hyperscaler cloud provider (“HCP”) cloud.

If new VIM resource types need to be handled by the NFVO and exposed on the NBI, explicit support for the new resource types must be added to the NFVO via development work. This can be a procedure with long lead time. Until support is added for the new resource types, the NFVO's template deployment process will ignore the resources unknown to the NFVO. Ignored resources are not considered in dependency checking, so if a deletion attempt fails due to dependencies of unsupported resources, that turns out only after a possibly time-consuming deletion attempt in the VIM, or may even result in errors during the operation of the virtual application later on.

Even if a VIM resource is recognized by the NFVO, not the whole set of its attributes may be stored in the data model of the NFVO and exposed on the NFVO's NBI.

Certain aspects of the disclosure and their embodiments may provide solutions to these or other challenges. Various embodiments described herein are applicable to NFVO systems like the one described above. In some embodiments, a generic way to specify new VIM resources via NFVO configuration (and not by hardcoding knowledge about the resource) is introduced. In additional or alternative embodiments, logic can be introduced to the NFVO to dynamically read and interpret the generic resource specification called reference definition. In some examples, a reference definition can specify the VIM resource type; a list of further match criteria; and a list of the attributes in the JavaScript Object Notation (“JSON”) representation of the VIM resource that refer to other resources by their VIM object ID and the type of the referred resource for each. In additional or alternative examples, the NFVO can read and store the full content (e.g., all attributes) of the VIM resources (deployed via VIM orchestration templates) that match the reference definitions. These resources can be called generic NFVO resources. In additional or alternative examples, the NFVO can store information about dependency of generic NFVO resources on NFVO assets or other generic NFVO resources. In additional or alternative embodiments, a generic application programmer interface (“API”) can be introduced to support query of the generic NFVO resources and their dependencies via the NFVO NBI. In additional or alternative embodiments, the asset deletion logic in the NFVO can be enhanced to prevent deletion of assets that any generic NVFO resource depends on.

In some embodiments, VIM objects can be recognized based on dynamically configurable match specifications. In additional or alternative embodiments, dependency relations between generic resources without coded semantic knowledge of their semantics can be automatically maintained by the NFVO. In additional or alternative embodiments, generic resources verbatim can be exposed on the NBI without coded semantic knowledge on their type.

In some examples, support is added for quickly storing and exposing new resource types. As the number of resource types may be very high (and grow dynamically, for example for a HCP), this may speed up adding support for query of new types of such VIM resources via the NFVO NBI.

In additional or alternative examples, the procedure to define new resource types becomes available to the customer. Further on, the reference check before deletion of assets is automatically expanded to include referring generic NFVO resources as well. This makes it possible to reject the deletion attempt of assets that are referred by other resources early, thereby avoid wasting capacity on failing deletion attempts in the VIM.

In additional or alternative examples, there is no need for the conventional procedure to develop (code, test, and release) support for recognizing new types of VIM resources and recognizing and storing their dependency relations. Instead, the enhanced NFVO functionality handles this automatically as configured.

In additional or alternative examples, the reference definition format is JSON, which can be applied (and extended as needed) for a wide variety of VIM types.

In additional or alternative examples, the reference definitions for each VIM resource type remain valid even when the VIM resources are enhanced with new attributes in the future in a backward compatible manner.

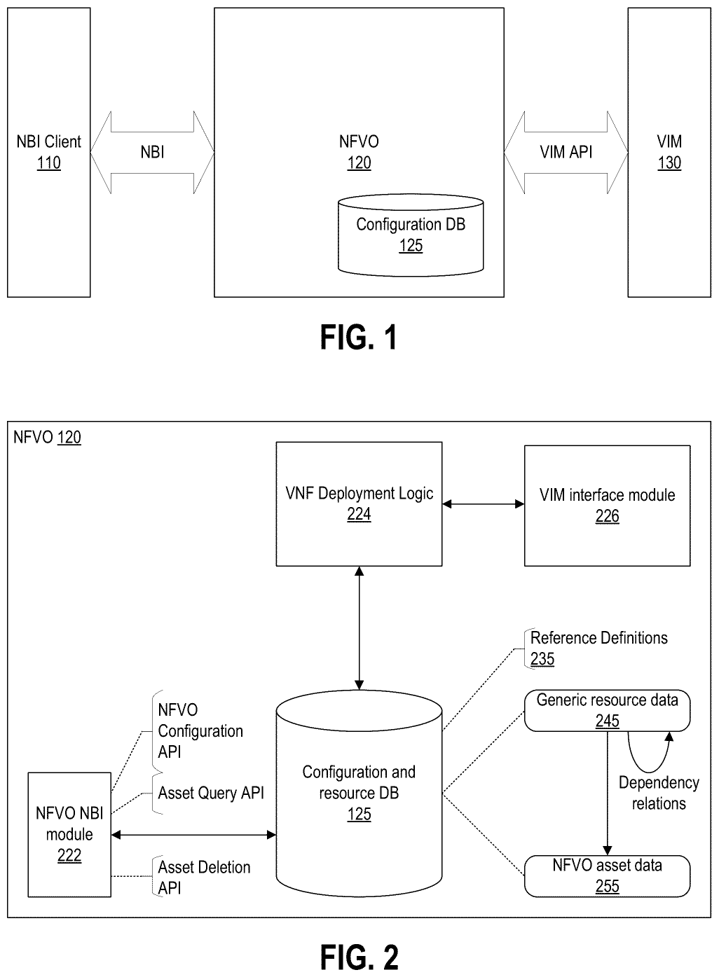

FIG. 1 illustrates an example of an orchestration management system overview. The orchestration management system includes a NVFO 120 communicatively coupled to a NBI client 110 and a VIM 130. The NFVO includes a configuration database (“DB”) 125.

In some embodiments, enhanced logic is added to the NFVO to allow storing reference definitions as part of configuration data in the configuration DB 125. In additional or alternative embodiments, enhanced logic is added to the NFVO to enhance the resource synchronization process between the NFVO and the VIM to recognize VIM resources that match any of the reference definitions. In additional or alternative embodiments, enhanced logic is added to the NFVO to store dependency relations between generic NFVO resources and other NFVO assets. In additional or alternative embodiments, enhanced logic is added to the NFVO to allow, based on the stored dependency relations, early reject deletion attempts on assets or generic NFVO resources that are referred by other generic NFVO resources.

FIG. 2 illustrates an example of a function allocation in the NFVO 120. In some examples, the configuration and resource databased (“DB”) 125 (also referred to herein as a NFVO DB 125) can store the reference definitions for the generic resources 235, the NFVO asset data 245, and the generic resource data 255.

In additional or alternative examples, the NFVO NBI module 222 can expose API calls to manage reference definitions, query NFVO assets (including generic resources), and handle deletion requests for NFVO assets (checks against generic resource dependencies).

In additional or alternative examples, the VIM interface module 226 handles communication with the VIM API.

In additional or alternative examples, the Virtual Network Function (“VNF”) deployment logic 224 performs VNF deployment by deploying orchestration templates in the VIM and populates the NFVO DB with data about the assets and generic resources (including their dependencies).

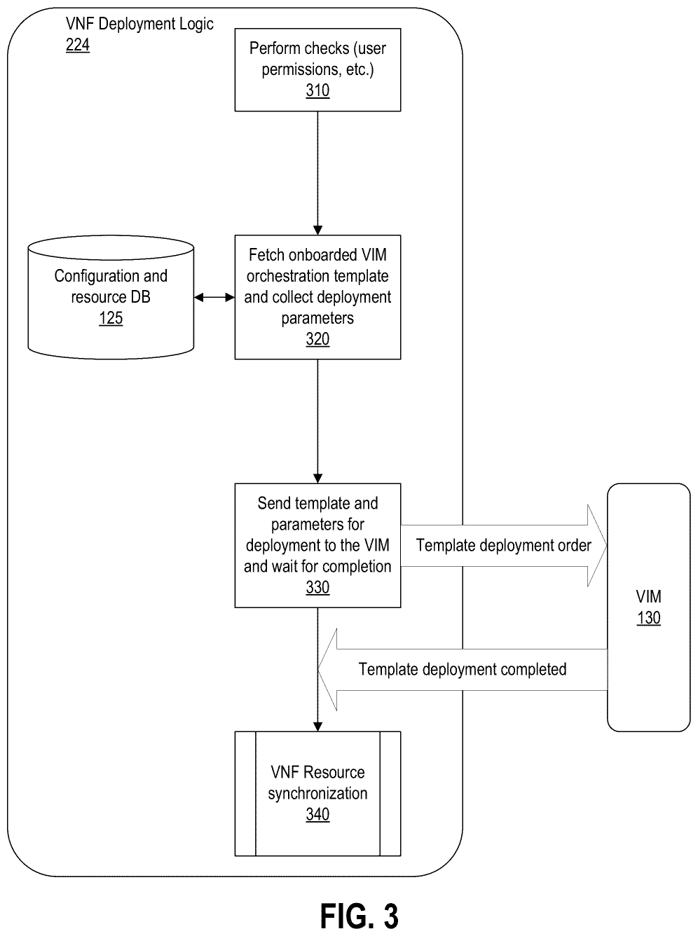

FIG. 3 outlines the VNF deployment logic 224 including examples of operations performed by the VNF deployment logic 224.

At block 310, the VNF deployment logic 224 performs checks (e.g., user permissions). At block 320, the VNF deployment logic 224 fetches onboarded VIM orchestration template from the configuration and resource DB 125. The VNF deployment logic 224 further collects deployment parameters. In some examples, the operations can include the orchestration template (also called VNF package in the NFVO) being onboarded to the NFVO.

At block 330, transmits template and parameters for deployment to the VIM 130 and wait for completion. The VIM 130 can also cover HCP virtual clouds as well. In some examples, when the user (e.g., the NBI client 110 of FIG. 1) requests deployment of the VNF package, the NFVO (e.g., 120 of FIG. 1) collects the template's configuration parameters from the client's request and sends that together with the template to the corresponding subsystem of the VIM 130 for orchestration. For an Openstack VIM, this would be HEAT, for Azure the Azure Resource Manager, for AWS the Cloudformation subsystem. The NFVO then waits until the orchestration in the VIM is completed.

At block 340, the VNF deployment logic 224 performs VNF resource synchronization. In some examples, this means that the resources deployed in the VIM 130 with the orchestration template are queried and stored in the NFVO resource and configuration DB 125.

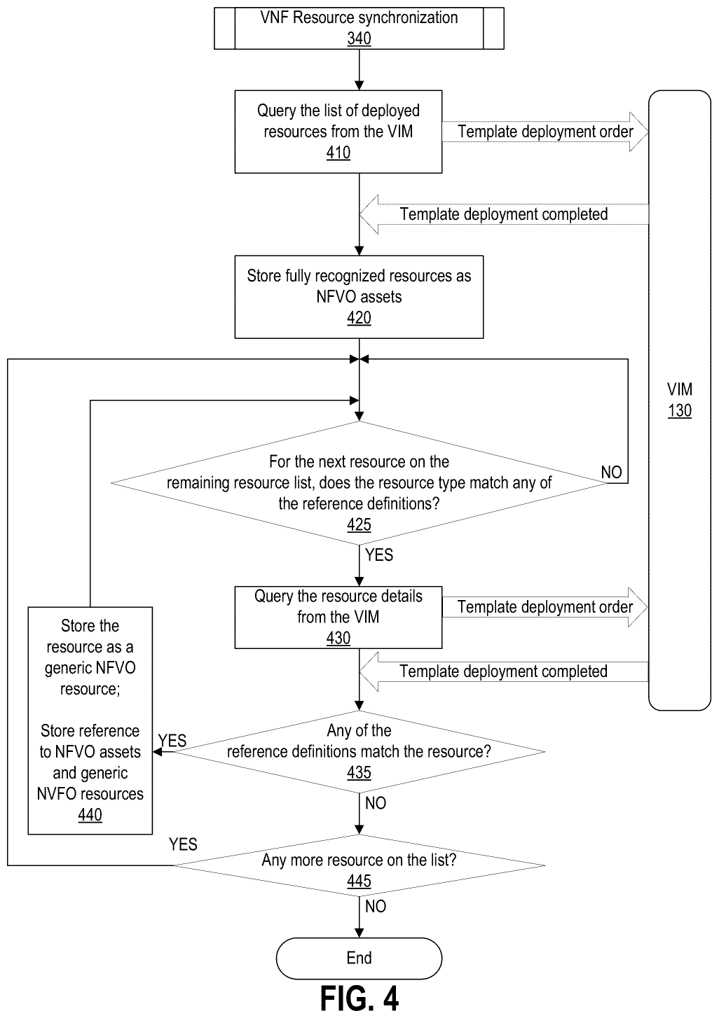

FIG. 4 illustrates an example of changes to the VNF Resource synchronization process 340. VNF resource synchronization 340 can start with querying the list of resources that have been created in the VIM via the template deployment process (block 410). In the legacy, the NFVO processes only the resources that are fully recognized by the NFVO and represented in the NFVO DB as NFVO assets. This handles the references and dependencies between NFVO assets based on the built-in logic.

At block 420, in some examples, virtual network interface cards (“VNIC”), virtual networks (“VN”), and subnet are fully recognized NVFO assets. The NFVO stores their most important attributes (but not all) in the NFVO DB (like internet protocol (“IP”) address ranges, media access control (“MAC”) address, etc) and the dependency relations between them (like the VNIC is connected to a subnet, and the subnet belongs to a VN. In this case, the VNIC depends on the subnet and the subnet depends on the VN.).

A series of operations (blocks 425, 430, 435, 440) can be performed for each of the queried resources that are not fully recognized by the NFVO.

In some examples, for each VIM resource, the NFVO checks if the VIM resource type matches the resource type in any of the reference definitions (block 425). If not, the NFVO can iterate to the next remaining resource. If the resource type matches, the NFVO can fetch the resource details from the VIM 130 (using the VIM object ID) (block 430).

In additional or alternative examples, the NFVO checks if the resource details match the match criteria in any reference definition for this VIM resource type (block 435). If not, the NFVO can iterate to the next remaining resource (block 445). If all the match criteria of a reference definition match, the NFVO can store the resource details in the NFVO DB (as a JSON object) (440). If references are defined too, the NFVO can extract the references that point to other resources (e.g., assets or generic resources) and store this relation (e.g., dependency). This operation may be fully completed only after all the generic resource details have been stored in the NFVO DB, because generic resources may refer to other generic resources within the same VNF.

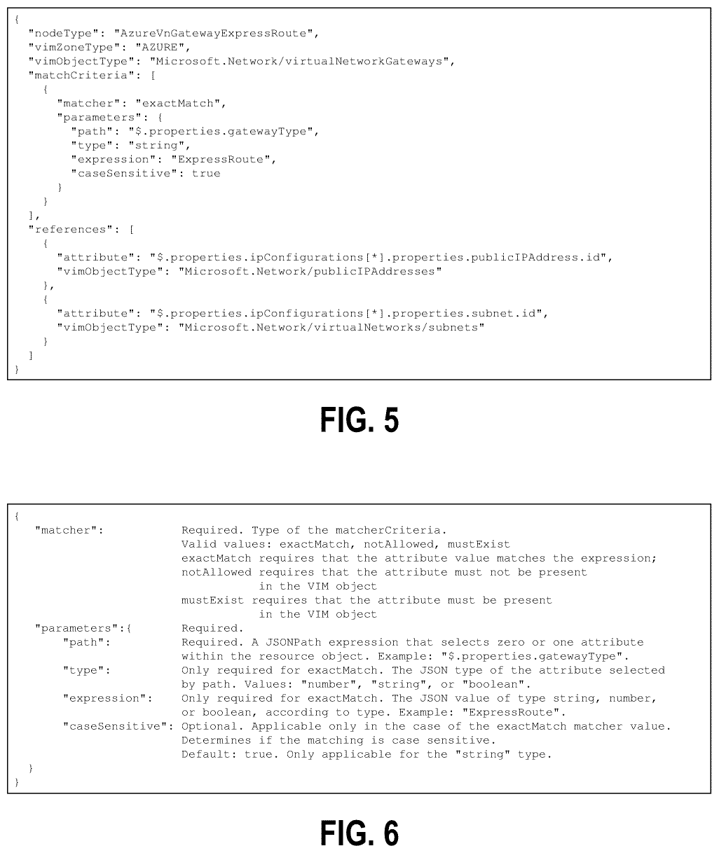

An example for adding generic support for a new VIM resource type is described below. In the example, the NFVO fully supports the virtual subnet objects as assets but does not support the Azure Virtual Network Gateways. To add support for that, the reference definition of FIG. 5 can be added to the NFVO via configuration in JSON format. This example is for Microsoft Azure VIM.

In this example, the attributes include NodeType, vimZoneType, vimObjectType, and matchCriteria. The NodeType refers to the name of the generic resource type, to be used within the NVFO. The vimZoneType points out the VIM zone type that the reference definition applies for (e.g. AZURE, AWS, Openstack). The vimObjectType refers to the VIM resource type, which can be used to filter the list of VIM resources. The matchCriteria is a further criteria for recognizing a generic VIM resource, which can be used at criteria matching. This can be a list of multiple match criterion. FIG. 6 is an example of a list of criteria items. The criteria items in the list are in a “logical AND” relationship, and during resource matching they are evaluated in the order defined by this list.

An Example of a VNF Resource Synchronization process including fetching the resource from the VIM is described below.

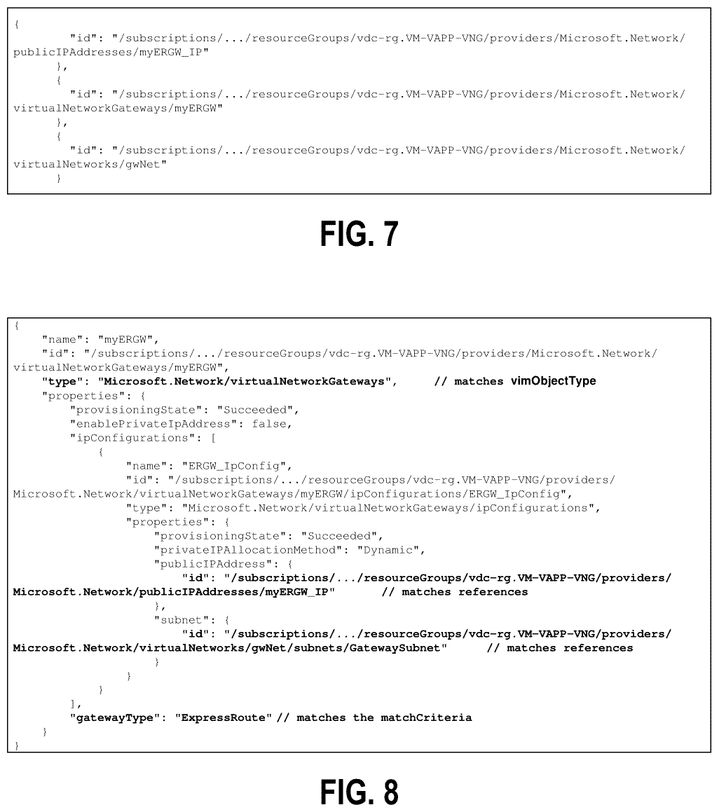

The reference definition shown in FIG. 5 is assumed. FIG. 7 illustrates an example a list of deployed resources returned by the VIM, which can be examined by the NFVO.

From the resources, the public IP address and the VN object is fully supported by the NFVO, so they are read and stored in the NFVO DB first.

The remaining resource, which is a Virtual Network Gateway, matches by type the reference definition above, see the clause: “vimObjectType”: “Microsoft.Network/virtualNetworkGateways”,

FIG. 8 illustrates an example of a query by the NVFO of the JSON object from the Azure VIM (Only some of the attributes are shown, comments with ‘//’ are added to point out the matched part of the reference definition).

In some examples, the NFVO finds that the JSON object matches the match criteria of a reference definition for this VIM object type, therefore it stores the JSON object as a generic resource object, marking that it belongs to the deployed VNF. For the data stored, see the generic resource details query of FIG. 10.

Then it attempts to locate the attributes referring to other resources via the JSONPath expressions in the references section of the reference definition. If the value of the referring JSON attributes matches the VIM object ID of fully supported assets, the dependency relations are stored. For the data stored, see the reference entry under generic resource details query of FIG. 10.

Additions to the NBI asset query API are described below.

The NBI client can query the JSON data of generic resources belonging to a VNF as part of VNF data stored in the NFVO. Additional data returned in the VNF data query response includes a list of generic resource summary information. The summary information includes: the identifier of the generic resource, to be used as key in the NFVO DB in generic resource details query, and its name; the generic resource type (defined with nodeType in the reference definition); the VIM object type; and the VIM object ID.

The motivation for having only summary information about the generic resources in the VNF query response is to prevent extensive size growth of the query response. To query the details of each generic resource, the new generic resource details query NBI operation is introduced, which returns data for a particular generic resource base on its ID (NFVO DB key): the generic resource name, ID (in the NFVO DB); the ID of the VNF containing the generic resource; the VIM object type; the VIM object (as a JSON object); and the list of references from the generic resource to other assets and generic resources.

Each reference entry specifies: the VNF ID of the referred resource it that is part of a VNF; the VIM object type; the VIM object ID; the ID and type of the referred resource/asset in the NFVO DB; and the identification of the JSON attribute of the generic resource that refers to the asset/resource, as a JSONPath expression.

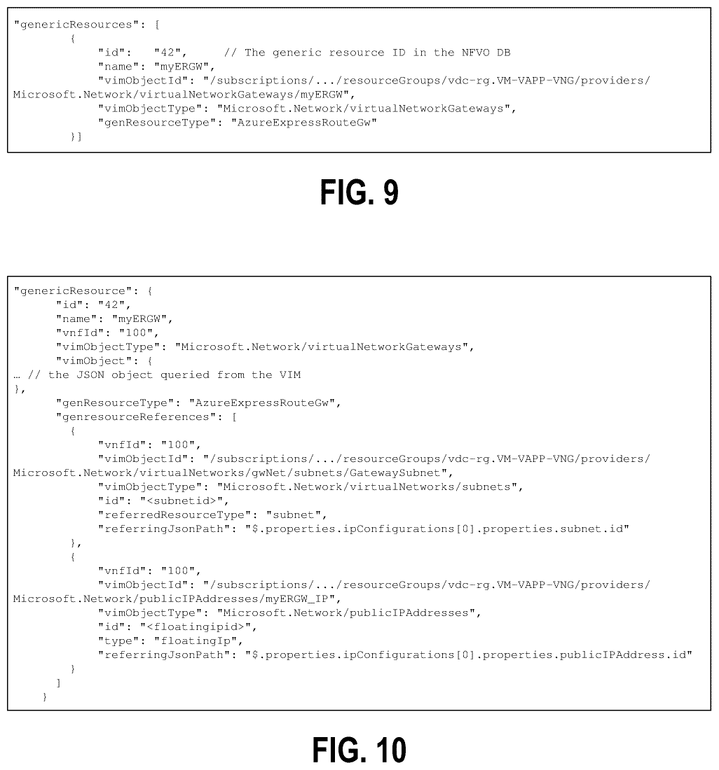

FIG. 9 illustrates an example of a VNF data query response addition (with 1 element in the list).

FIG. 10 illustrates an example of a generic resource details query response. The query can be made with the NFVO DB ID of the generic resource, acquired from the VNF data query response of FIG. 9.

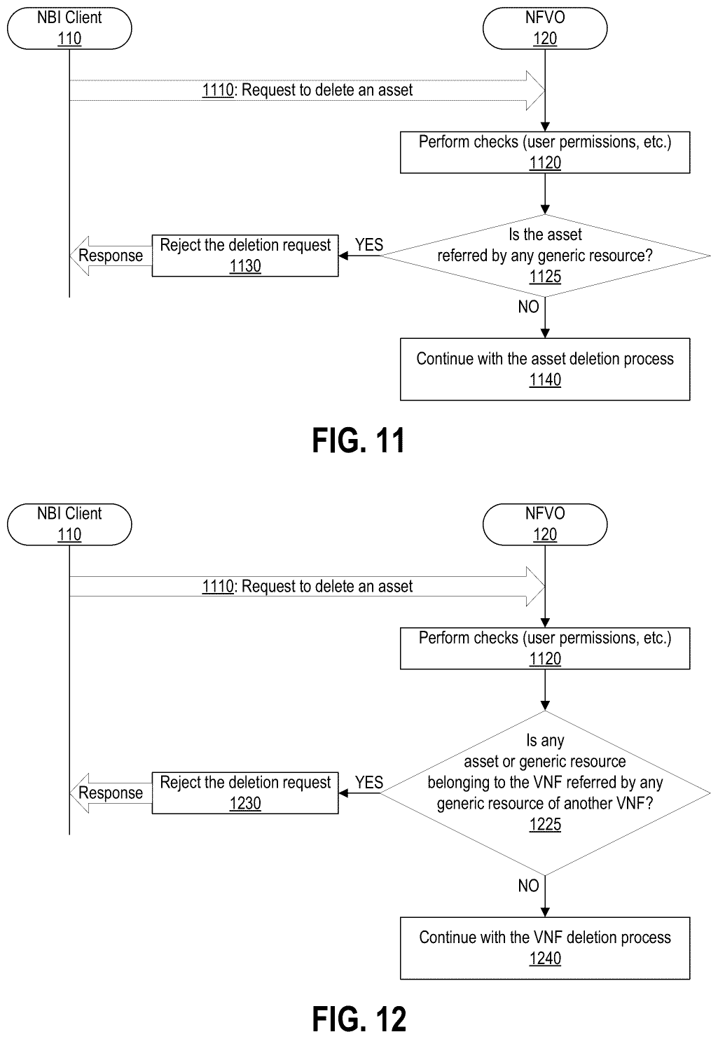

FIG. 11 illustrates an example of changes to the NBI asset deletion logic. At block 1110, NFVO 120 receives a request to delete an asset from the NBI client 110. At block 1120, in response to receiving the request to delete the asset, the NFVO 120 the NFVO performs checks (e.g., user permission). At block 1125, the NFVO 120 does an additional check to verify if the asset to be deleted is referred by any generic resource of any VNF. (This can be checked because the ID of the referred asset is stored in the NFVO DB as part of the dependency relation.) If yes, at block 1130 the NFVO rejects the deletion request, returning an error reason (response) to the NBI client 110 stating that the asset cannot be deleted as other resources depend on it. If no, at block 1140, the NFVO continues with the asset deletion process.

FIG. 12 illustrates an example of changes to the NFVO VNF deletion logic. At block 1110, NFVO 120 receives a request to delete an asset from the NBI client 110. At block 1120, in response to receiving the request to delete the asset, the NFVO 120 the NFVO performs checks (e.g., user permission).

At block 1125, the NFVO 120 does an additional check to verify if any asset belonging to the VNF to be deleted is referred by any generic resource of any other VNF. (This can be effectively checked because the ID of the referred VNF is stored with the references in the NFVO DB as part of the dependency relation.) If yes, at block 1230 it rejects the deletion request, returning an error reason (response) stating that the VNF cannot be deleted as other VNF's resources depend on it. If no, at block 1240, the NFVO continues with the asset deletion process.

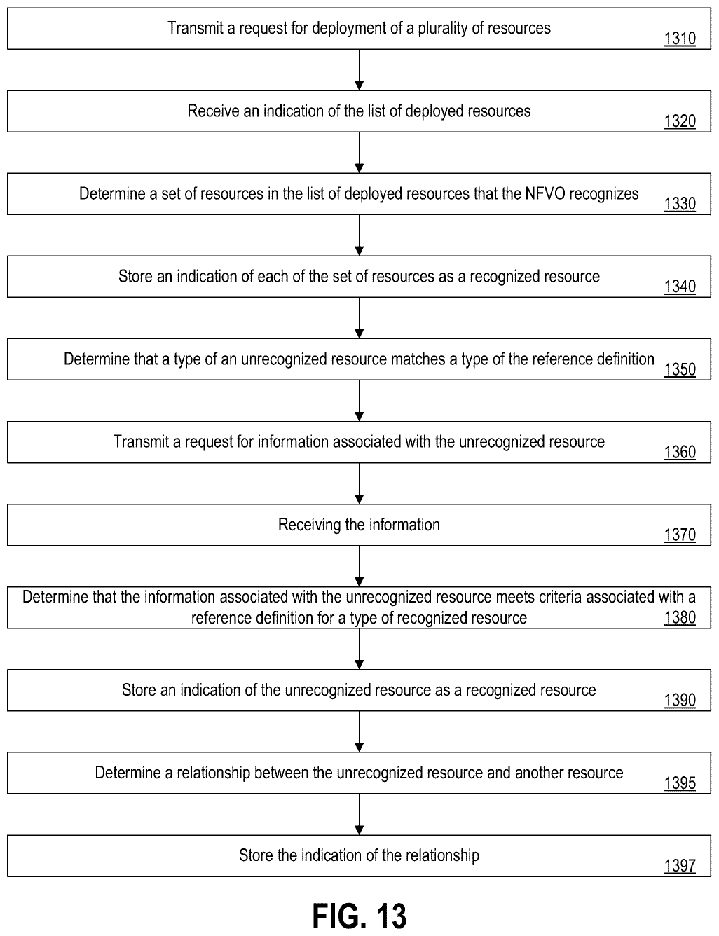

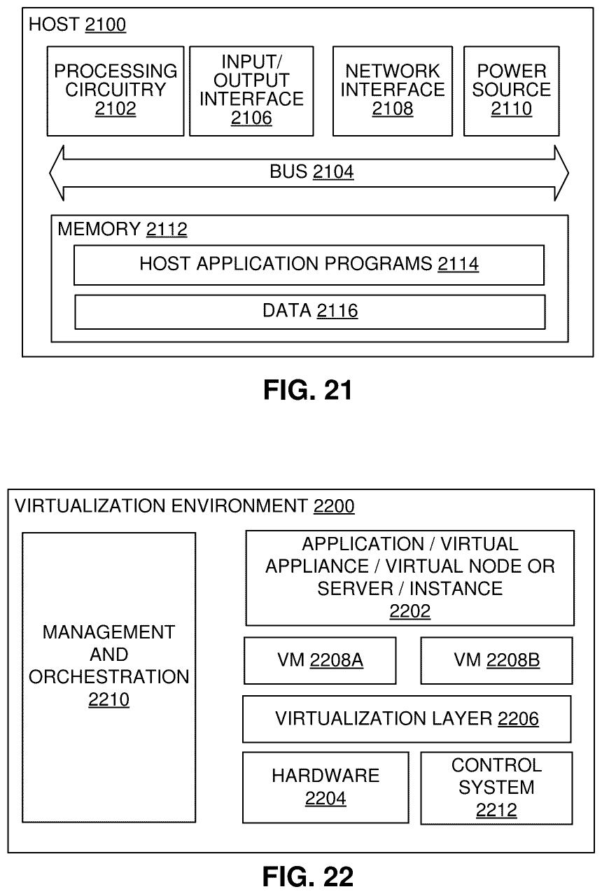

In the description that follows, the network node may be any of the host 2100, virtualized environment 2200, management and orchestration 2210, and hardware 2204. However, host 2100 (e.g., implemented in a management and orchestration 2210 of FIG. 22) shall be used to describe the functionality of the operations of the network node. Operations of the network node 2100 (implemented using the structure of FIG. 21) will now be discussed with reference to the flow charts of FIGS. 13-17 according to some embodiments of inventive concepts. For example, modules may be stored in memory 2112 of FIG. 21, and these modules may provide instructions so that when the instructions of a module are executed by respective network node processing circuitry 2102, processing circuitry 2102 performs respective operations of the flow charts.

FIG. 13 illustrates an example of operations performed by a network node configured to provide a NFVO in a virtualized environment.

At block 1310, processing circuitry 2102 transmits, via a network interface 2108, a request for deployment of a plurality of resources.

At block 1320, processing circuitry 2102 receives, via a network interface 2108, an indication of the list of deployed resources.

At block 1330, processing circuitry 2102 determines a set of resources in the list of deployed resources that the NFVO recognizes.

At block 1340, processing circuitry 2102 stores an indication of each of the set of resources as a recognized resource.

At block 1350, processing circuitry 2102 determines that a type of an unrecognized resource matches a type of the reference definition. In some embodiments, the unrecognized resource is a to be recognized resource or a to be processed resource. In some examples, the unrecognized resource has not yet been evaluated as to whether it is a fully recognized resource. The unrecognized resource may be a resource indicated in a list of deployed resources provided to the NFVO.

At block 1360, processing circuitry 2102 transmits, via a network interface 2108, a request for information associated with the unrecognized resource. In some embodiments, the information includes at least on of: an indication of a name of a generic resource type associated with the unrecognized resource; an indication of a virtualized infrastructure manager, VIM, zone type associated with the unrecognized resource; and an indication of a VIM resource type associated with the unrecognized resource.

In additional or alternative embodiments, transmitting the request includes transmitting the request to a virtualized infrastructure manager, VIM, the request including a VIM object identifier.

At block 1370, processing circuitry 2102 receives, via a network interface 2108, the information associated with the unrecognized resource. In some embodiments, receiving the information includes receiving the information from the VIM. In additional or alternative embodiments, the unrecognized resource includes an unrecognized VIM resource.

At block 1380, processing circuitry 2102 determines that the information associated with the unrecognized resource meets criteria associated with a reference definition for a type of recognized resource.

At block 1390, processing circuitry 2102 stores an indication of the unrecognized resource as a recognized resource. In some embodiments, storing the indication of the unrecognized resource includes storing the indication of the unrecognized resource as a generic NFVO resource. In additional or alternative embodiments, storing the indication of the unrecognized resource includes storing the indication of the unrecognized resource as a recognized resource in a configuration and resource database.

At block 1395, processing circuitry 2102 determines a relationship between the unrecognized resource and another resource.

At block 1397, processing circuitry 2002 stores the indication of the relationship.

Various operations from the flow chart of FIG. 13 may be optional with respect to some embodiments of network nodes and related methods. Regarding methods of example embodiment 1 (set forth below), for example, operations of blocks 1310, 1320, 1330, 1340, 1350, 1360, 1370, 1395, and 1397 may be optional.

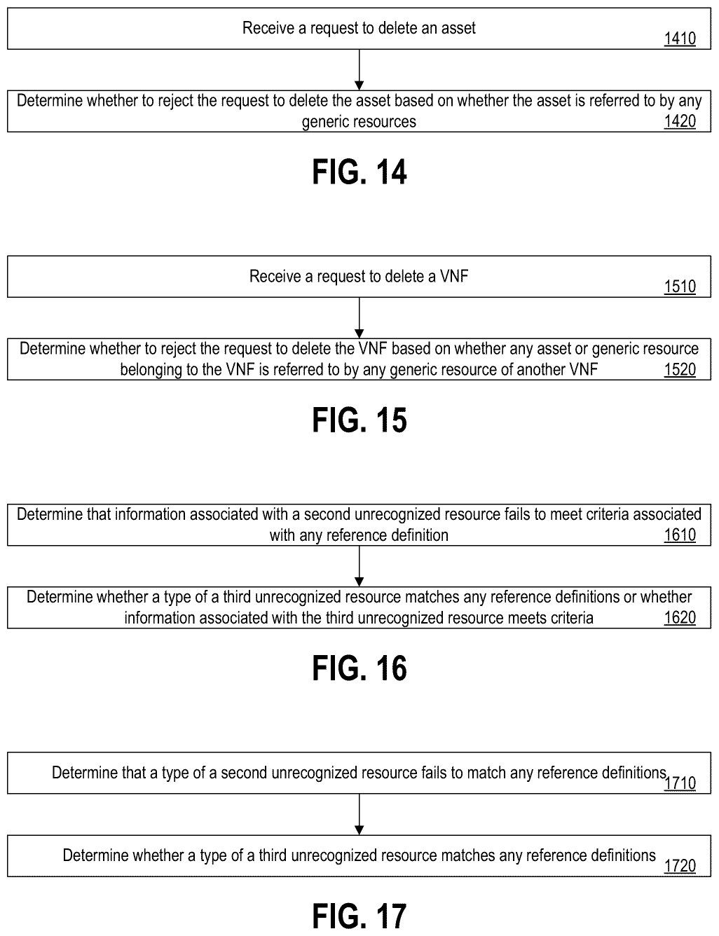

FIG. 14 illustrates an example of operations performed by a network node for handling a request to delete an asset. At block 1410, processing circuitry 2102 receives, via a network interface 2108, a request to delete an asset. At block 1420, processing circuitry 2102 determines whether to reject the request to delete the asset based on whether the asset is referred to by any generic resources.

FIG. 15 illustrates an example of operations performed by a network node for handling a request to delete a VNF. At block 1510, processing circuitry 2102 receives, via a network interface 2108, a request to delete a VNF. At block 1520, processing circuitry 2102 determines whether to reject the request to delete the VNF based on whether any asset or generic resource belonging to the VNF is referred to by any generic resource of another VNF.

FIGS. 16-17 illustrate an example of operations performed by a network node to handle when unrecognized resources fail to match any reference definitions.

At block 1610, processing circuitry 2102 determines that information associated with a second unrecognized resource fails to meet criteria associated with any reference definition. At block 1620, processing circuitry 2102 determines whether a type of a third unrecognized resource matches any reference definition or whether information associated with the third unrecognized resource meets criteria.

At block 1710, processing circuitry 2102 determines that a type of a second unrecognized resource fails to match any reference definitions. At block 1720, processing circuitry 2102 determines whether a type of a third unrecognized resource matches any reference definitions.

Various operations from the flow charts of FIGS. 14-17 may be optional with respect to some embodiments of network nodes and related methods.

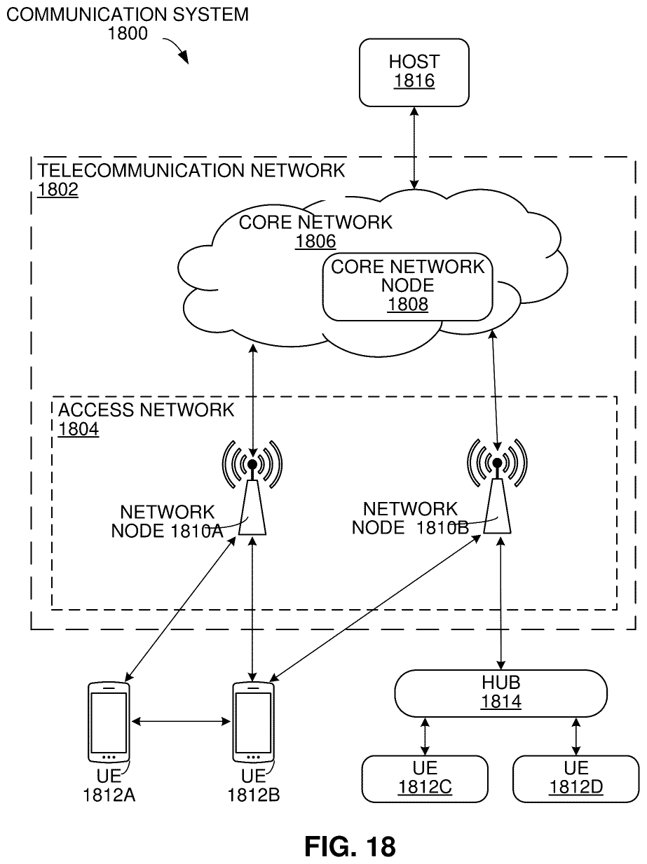

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810a and 1810b (one or more of which may be generally referred to as network nodes 1810), or any other similar 3^{rd} Generation Partnership Project (3GPP) access node or non-3GPP access point. The network nodes 1810 facilitate direct or indirect connection of user equipment (UE), such as by connecting UEs 1812a, 1812b, 1812c, and 1812d (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1814 communicates with the access network 1804 to facilitate indirect communication between one or more UEs (e.g., UE 1812c and/or 1812d) and network nodes (e.g., network node 1810b). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810b. The hub 1814 may also allow for a different communication scheme and/or schedule between the hub 1814 and UEs (e.g., UE 1812c and/or 1812d), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810b. In other embodiments, the hub 1814 may be a non-dedicated hub—that is, a device which is capable of operating to route communications between the UEs and network node 1810b, but which is additionally capable of operating as a communication start and/or end point for certain data channels.

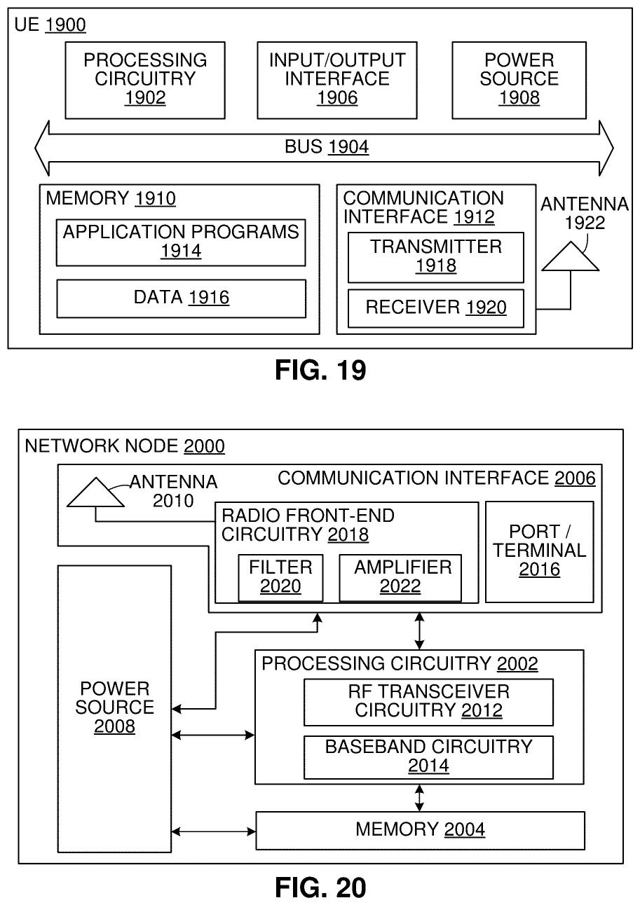

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-loT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2200 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208a and 2208b (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g. such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

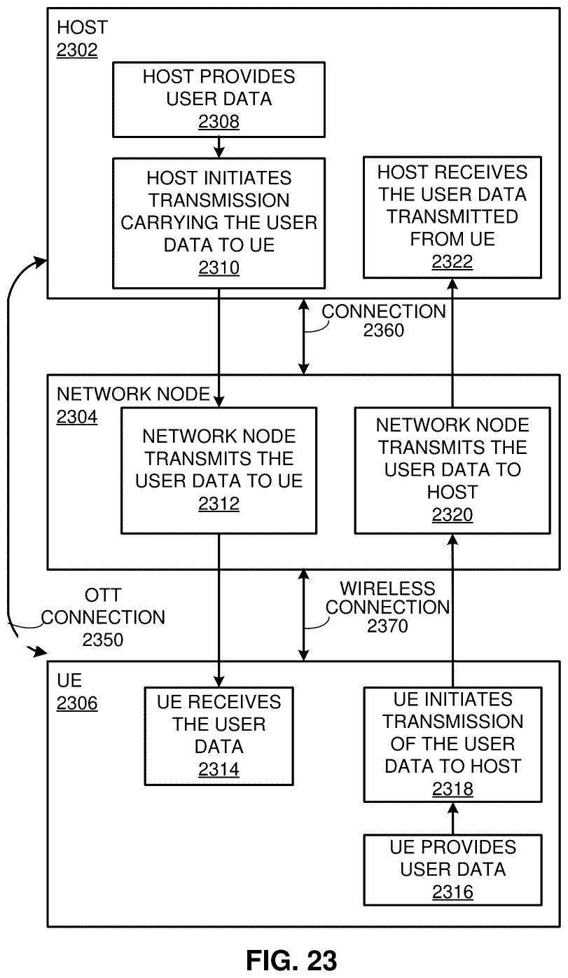

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812a of FIG. 18 and/or UE 1900 of FIG. 19), network node (such as network node 1810a of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350 extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360 and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment. More precisely, the teachings of these embodiments may allow new resource types to be quickly stored and exposed, which may speed up adding support for query of the new resource types.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes; the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a network node configured to provide a network function virtualization orchestrator, NFVO, in a virtualization environment, the method comprising:
determining that information associated with an unrecognized resource meets criteria associated with a reference definition for a type of recognized resource;
responsive to determining that the information associated with the unrecognized resource meets the criteria, storing an indication of the unrecognized resource as a recognized resource.

2. The method of claim 1, wherein the information comprises at least one of:
an indication of a name of a generic resource type associated with the unrecognized resource;
an indication of a virtualized infrastructure manager, VIM, zone type associated with the unrecognized resource; and
an indication of a VIM resource type associated with the unrecognized resource.

3. The method of claim 1, wherein storing the indication of the unrecognized resource comprises storing the indication of the unrecognized resource as a generic NFVO resource.

4. The method of any of claim 1, further comprising:
determining a relationship between the unrecognized resource and another resource; and
responsive to determining the relationship, storing an indication of the relationship.

5. The method of claim 4, further comprising:
receiving a request to delete an asset; and
responsive to receiving the request to delete the asset, determining whether to reject the request to delete the asset based on whether the asset is referred to by any generic resources.

6. The method of claim 4, further comprising
receiving a request to delete a virtual network function, VNF; and
responsive to receiving the request to delete the VNF, determining whether to reject the request to delete the VNF based on whether any asset or generic resource belonging to the VNF is referred to by any generic resources of another VNF.

7. The method of claim 1, wherein storing the indication of the unrecognized resource comprises storing the indication of the unrecognized resource as a recognized resource in a configuration and resource database.

8. The method of claim 1, further comprising:
determining that a type of the unrecognized resource matches a type of the reference definition;
responsive to determining that the type of the unrecognized resource matches the type of the reference definition, transmitting a request for the information, the request including an identifier of the unrecognized resource; and
responsive to transmitting the request, receiving the information.

9. The method of claim 8, wherein transmitting the request comprises transmitting the request to a virtualized infrastructure manager, VIM, the request comprising a VIM object identifier, and
wherein receiving the information comprises receiving the information from the VIM.

10. The method of claim 1, wherein the unrecognized resource comprises an unrecognized virtualized infrastructure manager, VIM, resource.

11. The method of claim 1, wherein the unrecognized resource comprises a first unrecognized resource of a plurality of unrecognized resources in a list of deployed resources.

12. The method of claim 11, further comprising:
transmitting a request for deployment of a plurality of resources;
responsive to transmitting the request for deployment of the plurality of resources, receiving an indication of the list of deployed resources; and
responsive to receiving the indication of the list of deployed resources, determining a set of resources in the list of deployed resources that the NFVO recognizes; and
storing an indication of each resource of the set of resources as a recognized resource.

13. The method of claim 1, further comprising:
determining that information associated with a second unrecognized resource of the plurality of unrecognized resources fails to meet criteria associated with any reference definition for a type of the second unrecognized resource; and
responsive to determining that the information associated with the second unrecognized resource fails to meet the criteria, determining at least one of:
whether a type of a third unrecognized resource of the plurality of unrecognized resources matches any reference definitions; and
whether information associated with the third unrecognized resource meets criteria associated with any reference definitions for a type of the third unrecognized resource.

14. The method of claim 1, further comprising:
determining that a type of a second unrecognized resource of the plurality of unrecognized resources fails to match any reference definitions; and
responsive to determining that the type of the second unrecognized resource fails to match any reference definitions, determining whether a type of a third unrecognized resource of the plurality of unrecognized resources matches any reference definitions.

15. A network node configured to provide a network function virtualization orchestrator, NFVO, in a virtualization environment, the network node comprising:
processing circuitry; and
memory coupled with the processing circuitry, wherein the memory includes instructions that when executed by the processing circuitry causes the network node to perform operations according to claim 1.

16. A network node configured to provide a network function virtualization orchestrator, NFVO, in a virtualization environment, and adapted to perform according to claim 1.

17. A computer program comprising program code to be executed by processing circuitry of a network node configured to provide a network function virtualization orchestrator, NFVO, in a virtualization environment, whereby execution of the program code causes the network node to perform operations according to claim 1.

18. A computer program product comprising a non-transitory storage medium including program code to be executed by processing circuitry of a network node configured to provide a network function virtualization orchestrator, NFVO, in a virtualization environment, whereby execution of the program code causes the network node to perform operations according to claim 1.
